(19) United States
(12) Patent Application Publication
(10) Pub. No.: US 2004/0252256 A1
(43) Pub. Date: Dec. 16, 2004

(54) Light guide plate for a backlight module

(75) Inventors: Chuan-Yu Hsu, Hsin-Chu City (TW); Ching-Wen Cheng, Kaousiung City (TW)

Correspondence Address: LOWE HAUPTMAN GILMAN & BERNER, LLP, Suite 310, 1700 Diagonal Road, Alexandria, VA, 22314, US

(73) Assignee: VEUTRON CORPORATION

(21) Appl. No.: 10/461,338

(22) Filed: Jun. 16, 2003

(51) Int. Cl. G02F 1/1335

(52) U.S. Cl. 349/67

(57) ABSTRACT

A backlight module includes a light guide plate, a lamp implemented beside one side surface of the light guide plate to project light beams into the light guide plate, a lamp housing surrounding the lamp to reflect light beams, and a plurality of cylinder reflectors are arranged from low to high protruding inside or outside the bottom of the light guide plate toward the opposite direction of the lamp, or are arranged from high to low protruding outside the bottom of the light guide plate toward the opposite direction of the lamp, or are arranged with non-uniform height protruding inside or outside the bottom of the light guide plate toward the opposite direction of the lamp.

### BACKGROUND OF THE INVENTION

1. Field of the Invention

The present invention relates to a light guide plate, especially relates to the arrangement of a plurality of cylinder reflectors of the light guide plate.

2. Description of the Prior Art

A liquid crystal panel has a backlight module to form a display apparatus. In the optical side, the backlight module has to satisfy the requirement of luminance, uniformity of luminance, and an angle of vision. In the electrical side, the backlight module has to satisfy the requirement of low power consumption and low noise. The structure of a backlight module can be approximately divided into a direct-light type and a side-light type. Herein a backlight module of a direct-light type has a light source implemented directly below a liquid crystal panel to illuminate the liquid crystal panel and a backlight module of a side-light type has a light source implemented beside a light guide plate below a liquid crystal panel to illuminate the liquid crystal panel by the emissive light reflected from the light guide plate.

Generally speaking, a light guide plate is made of transparent plastics, such as acrylic resin. A light guide plate can be a parallel plate, a wedge-shaped plate, or a double-wedge-shaped plate. The light beams injected into the light guide plate from the light source beside the light guide plate proceed with full reflection repeatedly inside the light guide plate by means of the refractive index difference between the light guide plate and air. The critical angle of the full reflection is about 42 degrees. The cylinder reflectors of the light guide plate take advantage of the property that the reflective angle of the light beams scattered by the cylinder reflectors is smaller than the critical angle of the full reflection to let the light beams be projected from the top surface of the light guide plate after reflected.

As shown in FIG. 1, a backlight module comprises a lamp 114, a lamp housing 112, a light guide plate 118, and a plurality of cylinder reflectors 116 of the same height. Traditionally, as shown in U.S. Pat. No. 5,703,667, the design of the cylinder reflectors 116 of a light guide plate 118 changes the bottom area of the cylinder reflectors 116 to get uniform luminance, or as shown in U.S. Pat. No. 6,123,431, the design of the cylinder reflectors 116 of a light guide plate 118 changes the interval between two cylinder reflectors 116 to get the desired light output. However, the two ways do not have good barrier ability to the parallel light injected into the light guide plate 118 and further waste the power. Accordingly, there is a need for uniformly reflecting parallel light by cylinder reflectors 116 to emit the light from the top surface of the light guide plate 118.

### SUMMARY OF THE INVENTION

The main purpose of the present invention is to provide the arrangement of the cylinder reflectors of a light guide plate of a backlight module by changing the height of the cylinder reflectors to adjust the ability to break the full reflection of light inside the light guide plate, to get the desired luminance of uniform light of the side-light type backlight module, to reinforce overall power efficiency, and to improve the ruminant performance.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows an illustrative chart of a light guide plate which has cylinder reflectors with the same height and the same interval therein of the prior art;

FIG. 2A shows an illustrative chart of a single-side-lamp and parallel light guide plate which has cylinder reflectors protruding from low to high from the bottom surface inside the light guide plate with the same interval from the lamp side to the opposite direction toward the lamp;

FIG. 2B shows an illustrative chart of a double-side-lamp and parallel light guide plate which has cylinder reflectors protruding from low to high from the bottom surface inside the light guide plate with the same interval from the lamp side to the opposite direction toward the lamp;

FIG. 2C shows an illustrative chart of a double-side-lamp and parallel light guide plate which has cylinder reflectors protruding with non-uniform height from the bottom surface inside the light guide plate with the same interval from the lamp side to the opposite direction toward the lamp;

FIG. 2D shows an illustrative chart of a single-side-lamp and wedge-shaped light guide plate which has cylinder reflectors protruding from low to high from the bottom surface inside the light guide plate with the same interval from the lamp side to the opposite direction toward the lamp;

FIG. 2E shows an illustrative chart of a double-side-lamp and double-wedge-shaped light guide plate which has cylinder reflectors protruding from low to high from the bottom surface inside the light guide plate with the same interval from the lamp side to the opposite direction toward the lamp;

FIG. 2F shows an illustrative chart of a double-side-lamp and double-wedge-shaped light guide plate which has cylinder reflectors protruding with non-uniform height from the bottom surface inside the light guide plate with the same interval from the lamp side to the opposite direction toward the lamp;

FIG. 3A shows an illustrative chart of a single-side-lamp and parallel light guide plate which has cylinder reflectors protruding from low to high from the bottom surface outside the light guide plate with the same interval from the lamp side to the opposite direction toward the lamp;

FIG. 3B shows an illustrative chart of a double-side-lamp and parallel light guide plate which has cylinder reflectors protruding from low to high from the bottom surface outside the light guide plate with the same interval from the lamp side to the opposite direction toward the lamp;

FIG. 3C shows an illustrative chart of a double-side-lamp and parallel light guide plate which has cylinder reflectors protruding with non-uniform height from the bottom surface outside the light guide plate with the same interval from the lamp side to the opposite direction toward the lamp;

FIG. 3D shows an illustrative chart of a single-side-lamp and wedge-shaped light guide plate which has cylinder reflectors protruding from low to high from the bottom surface outside the light guide plate with the same interval from the lamp side to the opposite direction toward the lamp;

FIG. 3E shows an illustrative chart of a double-side-lamp and double-wedge-shaped light guide plate which has cylinder reflectors protruding from low to high from the bottom surface outside the light guide plate with the same interval from the lamp side to the opposite direction toward the lamp;

FIG. 3F shows an illustrative chart of a double-side-lamp and double-wedge-shaped light guide plate which has cylinder reflectors protruding with non-uniform height from the bottom surface outside the light guide plate with the same interval from the lamp side to the opposite direction toward the lamp;

FIG. 4A shows an illustrative chart of a single-side-lamp and parallel light guide plate which has cylinder reflectors protruding from high to low from the bottom surface outside the light guide plate with the same interval from the lamp side to the opposite direction toward the lamp;

FIG. 4B shows an illustrative chart of a double-side-lamp and parallel light guide plate which has cylinder reflectors protruding from high to low from the bottom surface outside the light guide plate with the same interval from the lamp side to the opposite direction toward the lamp;

FIG. 4C shows an illustrative chart of a single-side-lamp and wedge-shaped light guide plate which has cylinder reflectors protruding from high to low from the bottom surface outside the light guide plate with the same interval from the lamp side to the opposite direction toward the lamp;

FIG. 4D shows an illustrative chart of a double-side-lamp and double-wedge-shaped light guide plate which has cylinder reflectors protruding from high to low from the bottom surface outside the light guide plate with the same interval from the lamp side to the opposite direction toward the lamp;

FIG. 5 shows an exploded view of a liquid crystal display device with a side-lamp backlight module;

FIG. 6 shows an exploded view of a liquid crystal display apparatus with a liquid crystal display as shown in FIG. 5;

FIG. 7A shows an illustrative chart of a crystal liquid display device, wherein the light guide plate is a double-side-lamp and parallel light guide plate which has cylinder reflectors protruding from low to high from the bottom surface inside the light guide plate with the same interval from the lamp side to the opposite direction toward the lamp;

FIG. 7B shows an illustrative chart of a crystal liquid display device, wherein the light guide plate is a double-side-lamp and parallel light guide plate which has cylinder reflectors protruding with non-uniform height from the bottom surface inside the light guide plate with the same interval from the lamp side to the opposite direction toward the lamp;

FIG. 7C shows an illustrative chart of a crystal liquid display device, wherein the light guide plate is a double-side-lamp and double-wedge-shaped light guide plate which has cylinder reflectors protruding from low to high from the bottom surface inside the light guide plate with the same interval from the lamp side to the opposite direction toward the lamp;

FIG. 7D shows an illustrative chart of a crystal liquid display device, wherein the light guide plate is a double-side-lamp and double-wedge-shaped light guide plate which has cylinder reflectors protruding with non-uniform height from the bottom surface inside the light guide plate with the same interval from the lamp side to the opposite direction toward the lamp;

FIG. 7E shows an illustrative chart of a crystal liquid display device, wherein the light guide plate is a double-side-lamp and parallel light guide plate which has cylinder reflectors protruding from low to high from the bottom surface outside the light guide plate with the same interval from the lamp side to the opposite direction toward the lamp;

FIG. 7F shows an illustrative chart of a crystal liquid display device, wherein the light guide plate is a double-side-lamp and parallel light guide plate which has cylinder reflectors protruding with non-uniform height from the bottom surface outside the light guide plate with the same interval from the lamp side to the opposite direction toward the lamp;

FIG. 7G shows an illustrative chart of a crystal liquid display device, wherein the light guide plate is a double-side-lamp and double-wedge-shaped light guide plate which has cylinder reflectors protruding from low to high from the bottom surface outside the light guide plate with the same interval from the lamp side to the opposite direction toward the lamp;

FIG. 7H shows an illustrative chart of a crystal liquid display device, wherein the light guide plate is a double-side-lamp and double-wedge-shaped light guide plate which has cylinder reflectors protruding with non-uniform height from the bottom surface outside the light guide plate with the same interval from the lamp side to the opposite direction toward the lamp;

FIG. 7I shows an illustrative chart of a crystal liquid display device, wherein the light guide plate is a double-side-lamp and parallel light guide plate which has cylinder reflectors protruding from high to low from the bottom surface outside the light guide plate with the same interval from the lamp side to the opposite direction toward the lamp; and

FIG. 7J shows an illustrative chart of a crystal liquid display device, wherein the light guide plate is a double-side-lamp and double-wedge-shaped light guide plate which has cylinder reflectors protruding from high to low from the bottom surface outside the light guide plate with the same interval from the lamp side to the opposite direction toward the lamp.

### DESCRIPTION OF THE PREFERRED EMBODIMENT

Some embodiments of the invention will be described exquisitely as below. Besides, the invention can also be practiced extensively in other embodiments. That is to say, the scope of the invention should not be restricted by the proposed embodiments. The scope of the invention should be based on the claims proposed later.

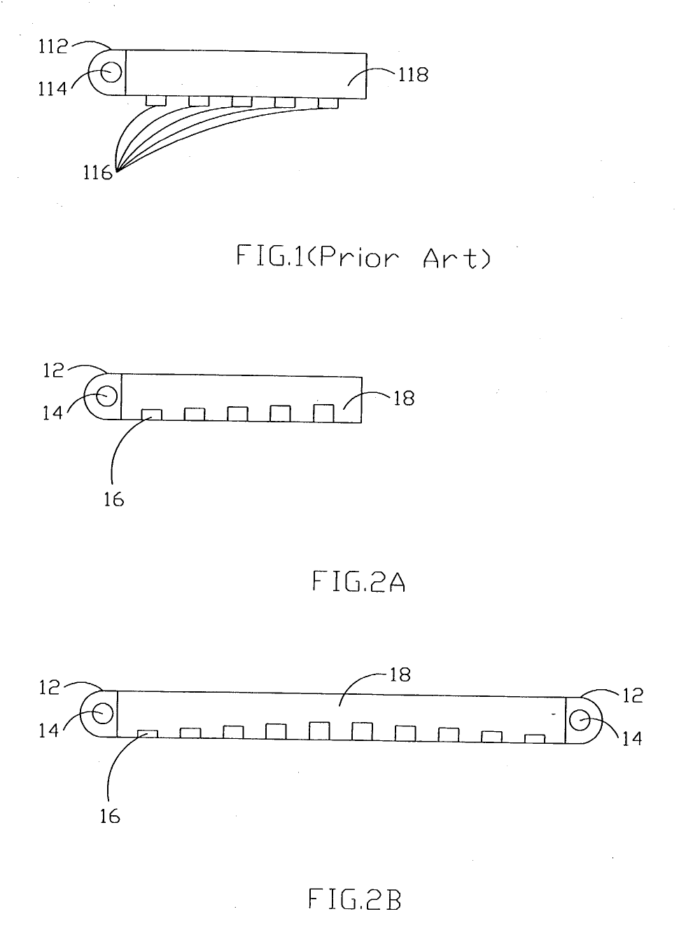

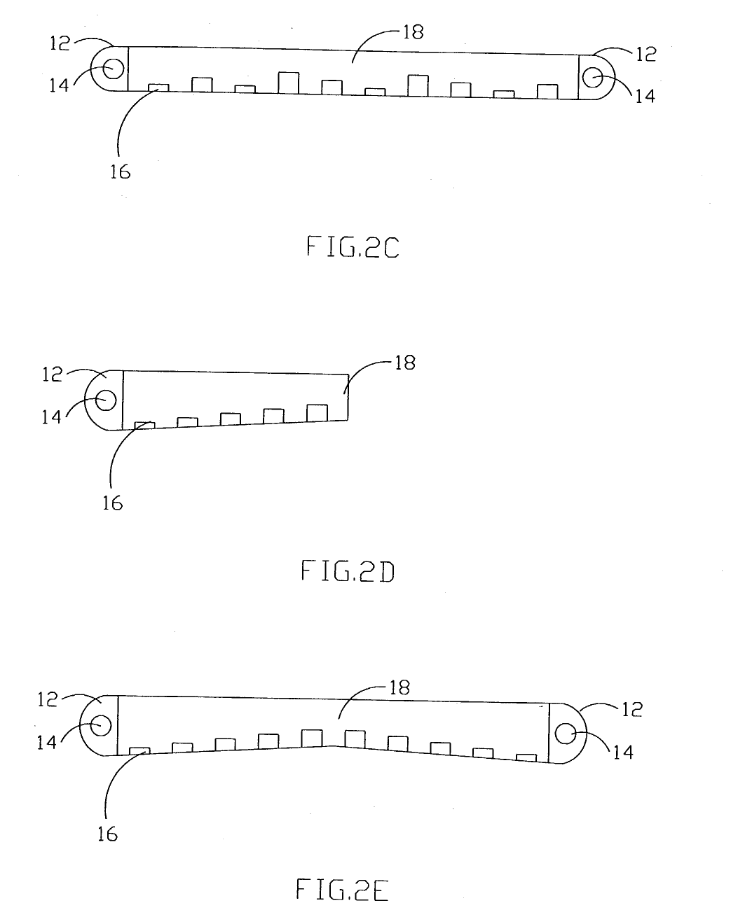

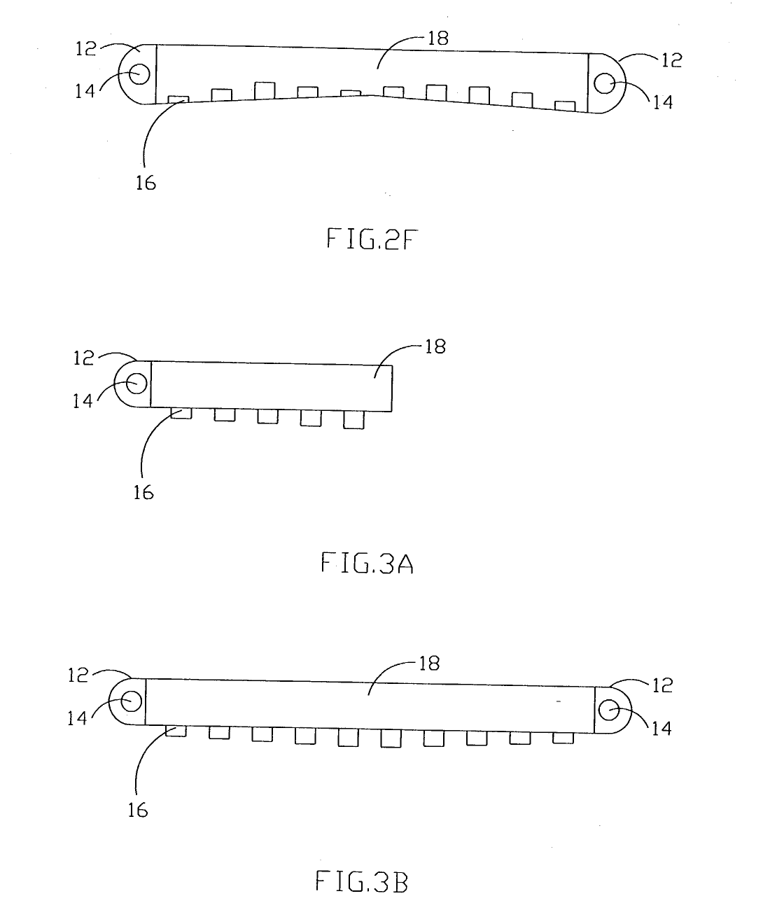

One preferred embodiment of the present invention is as shown in FIG. 2A-2F. A backlight module has a light guide plate 18, one or a plurality of lamps 14 coupled to the sides of the light guide plate 18, one or a plurality of lamp housings surrounding the one or the plurality of lamps 14, and a plurality of cylinder reflectors 16 protruding from the bottom surface inside the light guide plate 18.

As shown in FIG. 2A, a plurality of cylinder reflectors 16 protruding from low to high from the bottom surface inside the light guide plate 18 with the same interval from the lamp 14 side to the opposite direction toward the lamp 14. The plurality of cylinder reflectors 16 can be formed on the bottom surface of the light guide plate 18 at the same time when the light guide plate 18 is formed, or the plurality of cylinder reflectors 16 can be formed after drilling holes on the bottom surface of the light guide plate 18. Because the plurality of cylinder reflectors 16 protrude from the bottom surface inside the light guide plate 18 from low to high with a fixed interval, the arrangement of the plurality of cylinder reflectors 16 is capable of reflecting parallel light far away from the lamp 14 and breaking the full reflection of light to emit the light uniformly from the top surface of the light guide plate 18.

As shown in FIG. 2B, the difference between FIG. 2B and FIG. 2A lies in the backlight module of FIG. 2B is a double-side-lamp backlight module. A plurality of cylinder reflectors 16 protrude from the bottom surface inside the light guide plate 18 from low to high from two sides to the center of the light guide plate 18. The difference between FIG. 2C and FIG. 2B lies in that a plurality of cylinder reflectors 16 protrude from the bottom surface inside the light guide plate 18 with non-uniform height in FIG. 2C from two sides to the center of the light guide plate 18 considering the light intensity distribution of the lamp in order to reflect the light to project uniformly from the top surface of the light guide plate 18. FIG. 2D-2F are similar to FIG. 2A-2C, the main difference between the two groups of figures lies in the shape of the light guide plate 18. The light guide plate 18 of FIG. 2A-2C is a parallel light guide plate, the light guide plate 18 of FIG. 2D is a wedge-shaped light guide plate, and the light guide plate 18 of FIG. 2E-2F is a double-wedge-shaped light guide plate. As shown in FIG. 2D-2E, a plurality of cylinder reflectors 16 protrude from the bottom surface inside the light guide plate 18 from low to high with the same interval from the lamp 14 side to the opposite direction toward the lamp 14. As shown in FIG. 2F, a plurality of cylinder reflectors 16 protrude from the bottom surface inside the light guide plate 18 with non-uniform height with the same interval from the lamp 14 side to the opposite direction toward the lamp 14.

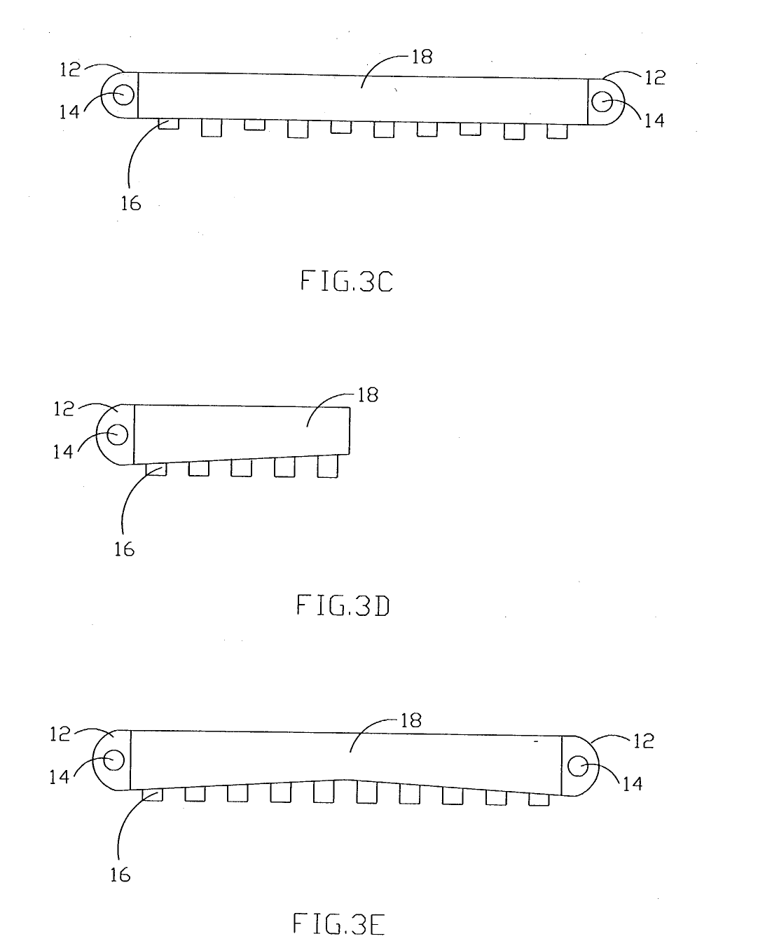

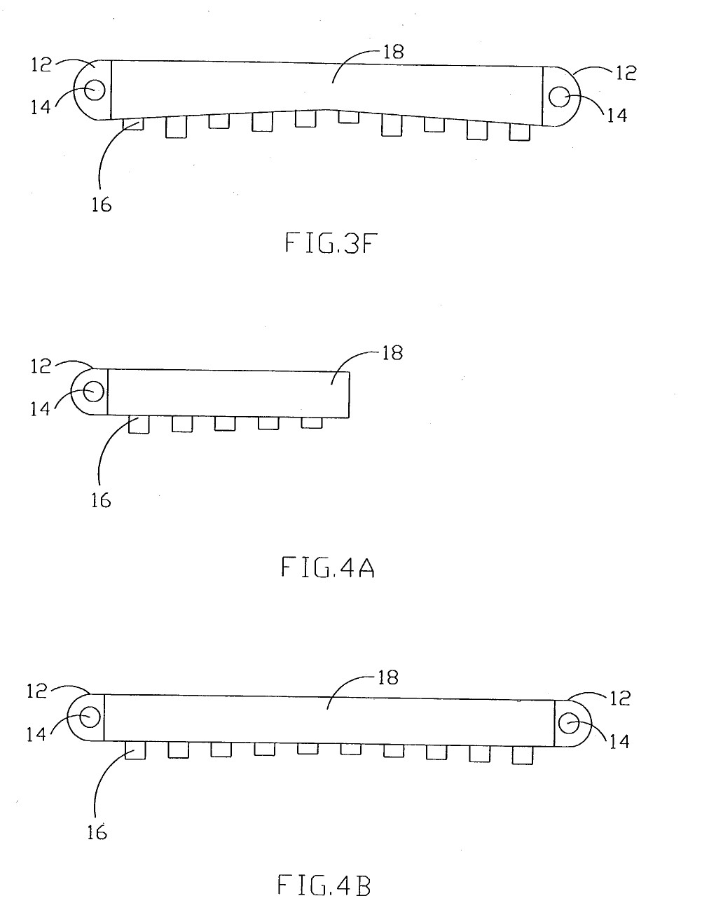

Another preferred embodiment of the present invention is as shown in FIG. 3A-3F. A backlight module has a light guide plate 18, one or a plurality of lamps 14 coupled to the sides of the light guide plate 18, one or a plurality of lamp housings surrounding the one or the plurality of lamps 14, and a plurality of cylinder reflectors 16 protruding from the bottom surface outside the light guide plate 18.

As shown in FIG. 3A, a plurality of cylinder reflectors 16 protruding from low to high from the bottom surface inside the light guide plate 18 with the same interval from the lamp 14 side to the opposite direction toward the lamp 14. The plurality of cylinder reflectors 16 can be formed on the bottom surface of the light guide plate 18 at the same time when the light guide plate 18 is formed, or the plurality of cylinder reflectors 16 can be formed after drilling holes on the bottom surface of the light guide plate 18. Because the plurality of cylinder reflectors 16 protrude from the bottom surface outside the light guide plate 18 from low to high with a fixed interval, the arrangement of the plurality of cylinder reflectors 16 is capable of reflecting parallel light far away from the lamp 14 and breaking the full reflection of light to emit the light uniformly from the top surface of the light guide plate 18.

As shown in FIG. 3B, the difference between FIG. 3B and FIG. 3A lies in the backlight module of FIG. 3B is a double-side-lamp backlight module. A plurality of cylinder reflectors 16 protrude from the bottom surface outside the light guide plate 18 from low to high from two sides to the center of the light guide plate 18. The difference between FIG. 3C and FIG. 3B lies in that a plurality of cylinder reflectors 16 protrude from the bottom surface inside the light guide plate 18 with non-uniform height in FIG. 3C from two sides to the center of the light guide plate 18 considering the light intensity distribution of the lamp in order to reflect the light to project uniformly from the top surface of the light guide plate 18. FIG. 3D-3F are similar to FIG. 3A-3C, the main difference between the two groups of figures lies in the shape of the light guide plate 18. The light guide plate 18 of FIG. 3A-3C is a parallel light guide plate, the light guide plate 18 of FIG. 3D is a wedge-shaped light guide plate, and the light guide plate 18 of FIG. 3E-3F is a double-wedge-shaped light guide plate. As shown in FIG. 3D-3E, a plurality of cylinder reflectors 16 protrude from the bottom surface outside the light guide plate 18 from low to high with the same interval from the lamp 14 side to the opposite direction toward the lamp 14. As shown in FIG. 3F, a plurality of cylinder reflectors 16 protrude from the bottom surface outside the light guide plate 18 with non-uniform height with the same interval from the lamp 14 side to the opposite direction toward the lamp 14.

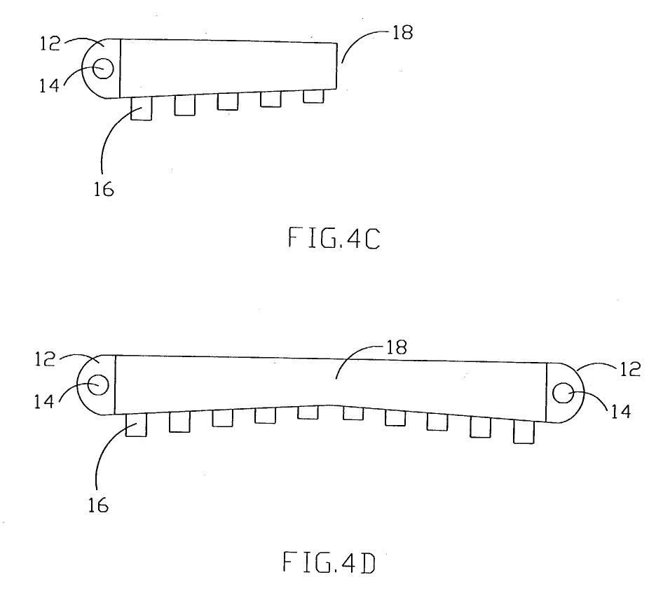

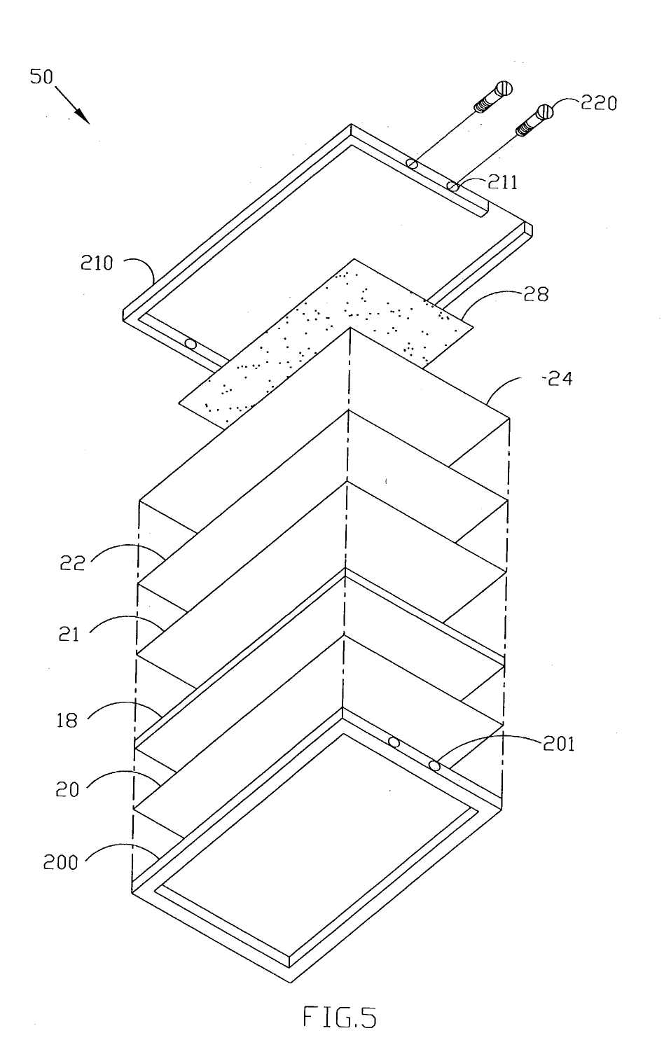

The other preferred embodiment of the present invention is as shown in FIG. 4A-4D. A backlight module has a light guide plate 18, one or a plurality of lamps 14 coupled to the sides of the light guide plate 18, one or a plurality of lamp housings surrounding the one or the plurality of lamps 14, and a plurality of cylinder reflectors 16 protruding from the bottom surface outside the light guide plate 18.

As shown in FIG. 4A, a plurality of cylinder reflectors 16 protruding from high to low from the bottom surface inside the light guide plate 18 with the same interval from the lamp 14 side to the opposite direction toward the lamp 14. The plurality of cylinder reflectors 16 can be formed on the bottom surface of the light guide plate 18 at the same time when the light guide plate 18 is formed, or the plurality of cylinder reflectors 16 can be formed after drilling holes on the bottom surface of the light guide plate 18. Because the plurality of cylinder reflectors 16 protrude from the bottom surface outside the light guide plate 18 from high to low with a fixed interval, the arrangement of the plurality of cylinder reflectors 16 is capable of reflecting parallel light far away from the lamp 14 and breaking the full reflection of light to emit the light uniformly from the top surface of the light guide plate 18.

As shown in FIG. 4B, the difference between FIG. 4B and FIG. 4A lies in the backlight module of FIG. 4B is a double-side-lamp backlight module. A plurality of cylinder reflectors 16 protrude from the bottom surface outside the light guide plate 18 from high to low from two sides to the center of the light guide plate 18. FIGS. 4C-4D are similar to FIGS. 4A-4B, the main difference between the two groups of figures lies in the shape of the light guide plate 18. The light guide plate 18 of FIGS. 4A-4B is a parallel light guide plate, the light guide plate 18 of FIG. 4C is a wedge-shaped light guide plate, and the light guide plate 18 of FIG. 4D is a double-wedge-shaped light guide plate. As shown in FIGS. 4C-4D, a plurality of cylinder reflectors 16 protrude from the bottom surface outside the light guide plate 18 from high to low with the same interval from the lamp 14 side to the opposite direction toward the lamp 14.

The side-lamp backlight module is capable of being a light source of a liquid crystal display device 50. As shown in FIG. 5, the figure shows an exploded view of a liquid crystal display device 50 with a side-lamp backlight module. For the simplification of the figure, some components such as the lamp 14 and the lamp housing 12 are omitted from the figure. The plurality of cylinder reflectors 16 located around the bottom surface of the light guide plate 18 are also omitted in the figure. The liquid crystal display device as shown in FIG. 5 from bottom to top of the figure includes a first support frame 200, a reflector 20, a light guide plate 18, a protection sheet 21, a prism sheet 22, a diffuser 24, a liquid crystal panel 28, and a second support frame 210. On the side surface of the first support frame 200, a plurality of screw holes 201 are formed. And on the same side surface of the second support frame 210, a plurality of screw holes 211 are formed aligned with the screw holes 201 of the first support frame 200. The components of the liquid crystal display device 50 can be combined by fastening devices such as screws 220, which are affixed to the screw holes 211 of the second support frame 210 and the screw holes 201 of the first support frame 200. Furthermore, the prism sheet 22 is used to aggregrate light emitted by the light guide plate 18 to focus on the range of the angle of vision to reinforce the light intensity of the liquid crystal display device 50. The diffuser 24 is used to diffuse light emitted by the light guide plate 18 to improve the uniformity of luminance of the liquid crystal display device 50. The components shown in FIG. 5 could be interchanged with each other, such as the diffuser 24 could be interchanged with the protection sheet 21, an additional prism sheet(not shown) could be added above the prism sheet 22 wherein the two prism sheets are perpendicular to one another, or the prism sheet could be omitted and the top surface of the light guide plate 18 is formed as a prism sheet.

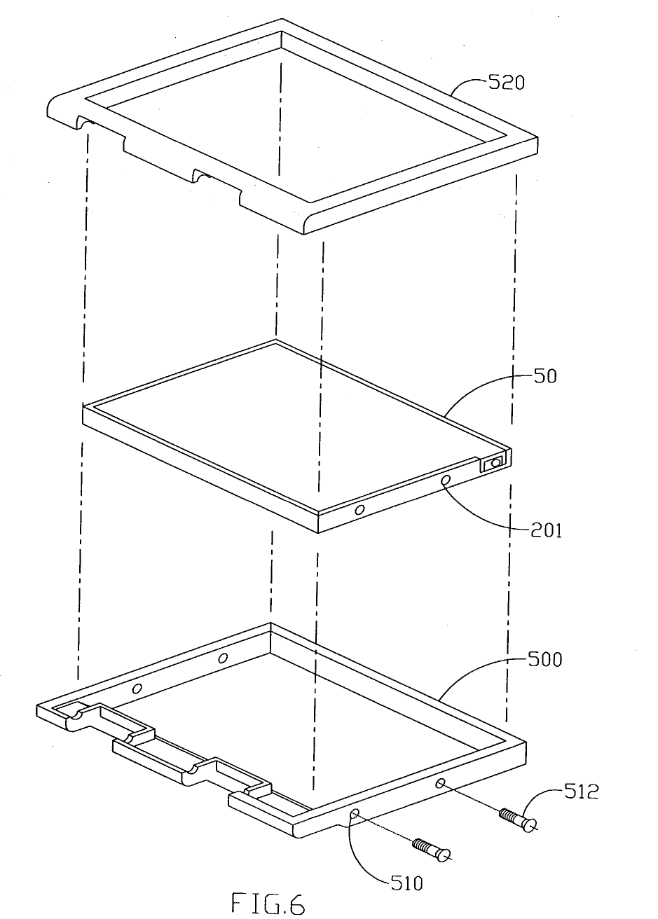

As shown in FIG. 6, the figure shows an exploded view of a liquid crystal display apparatus with a liquid crystal display as shown in FIG. 5, wherein the liquid crystal display device 50 is combined with a rear case 500 and a front case 520. On the side surface of the rear case 500, a plurality of screw holes 510 are aligned with the plurality of screw holes 211 of the second support frame 210. The rear case 500 and the liquid crystal display device 50 are joined to each other by fastening devices such as screws 512, which are affixed to the screw holes 510 and screw holes 211. Further, the rear case 500 lodges in the front case 520 to include the liquid crystal display device 50 between the rear case 500 and the front case 520.

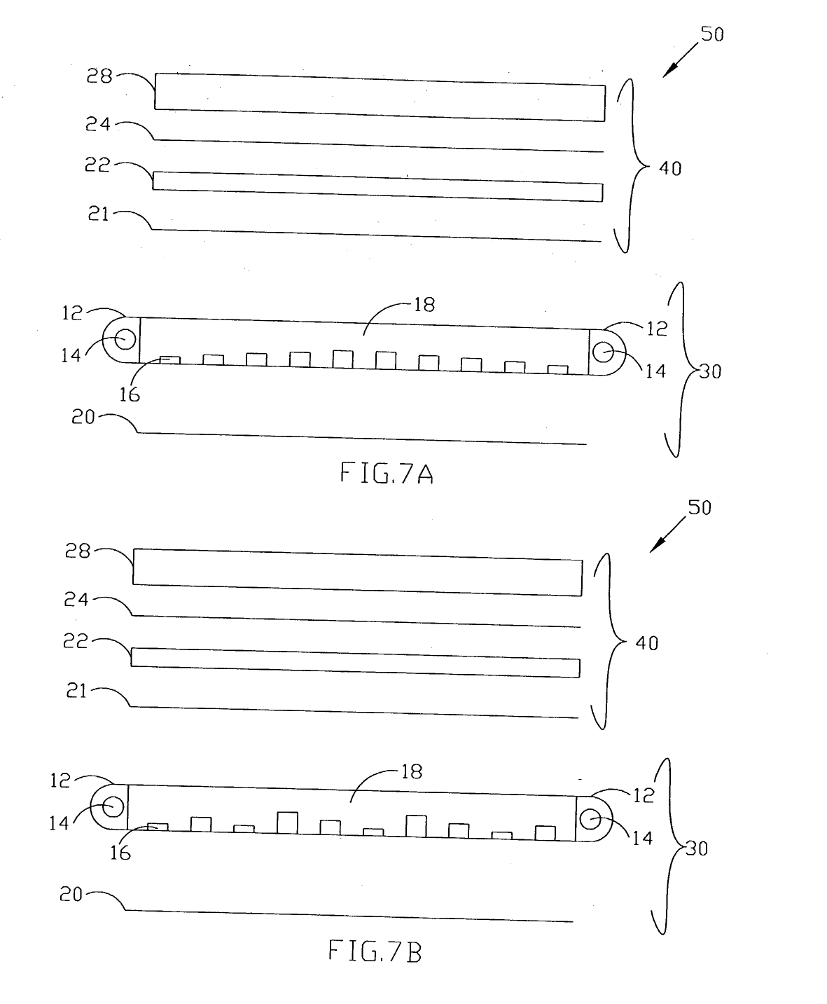

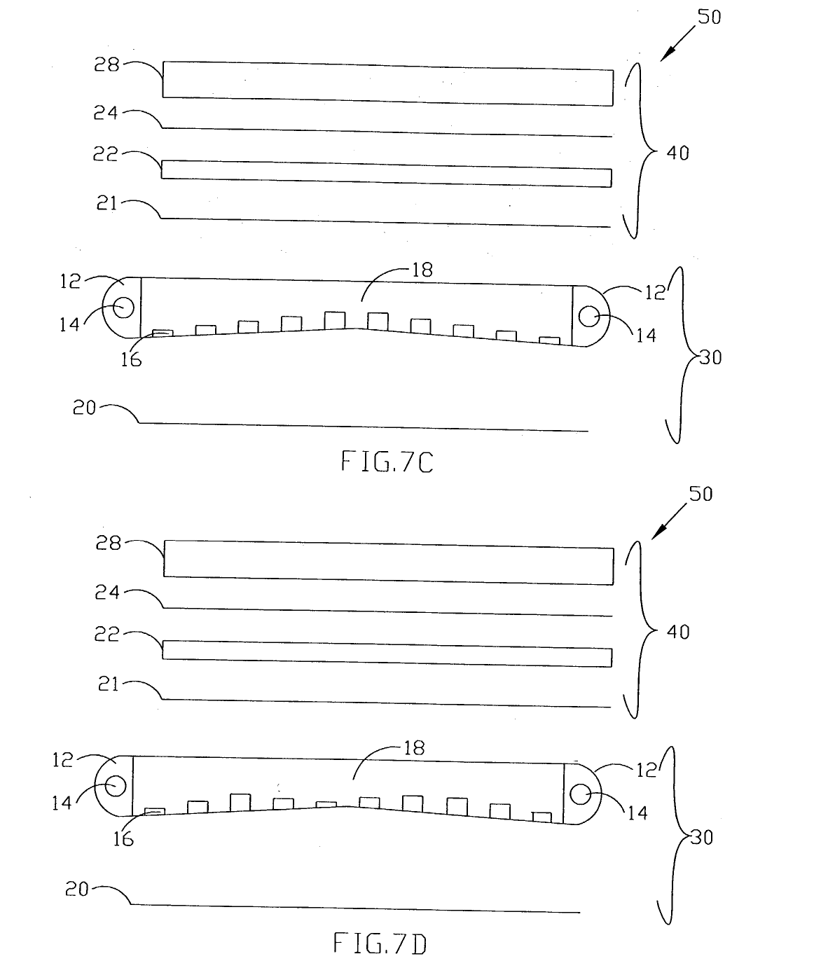

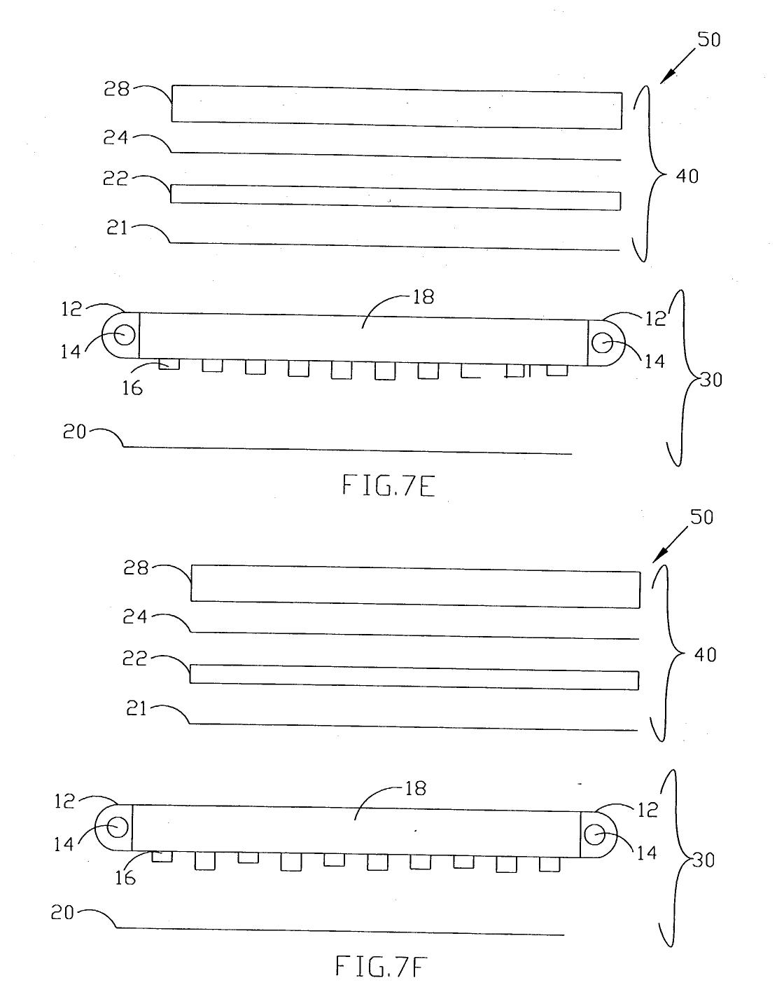

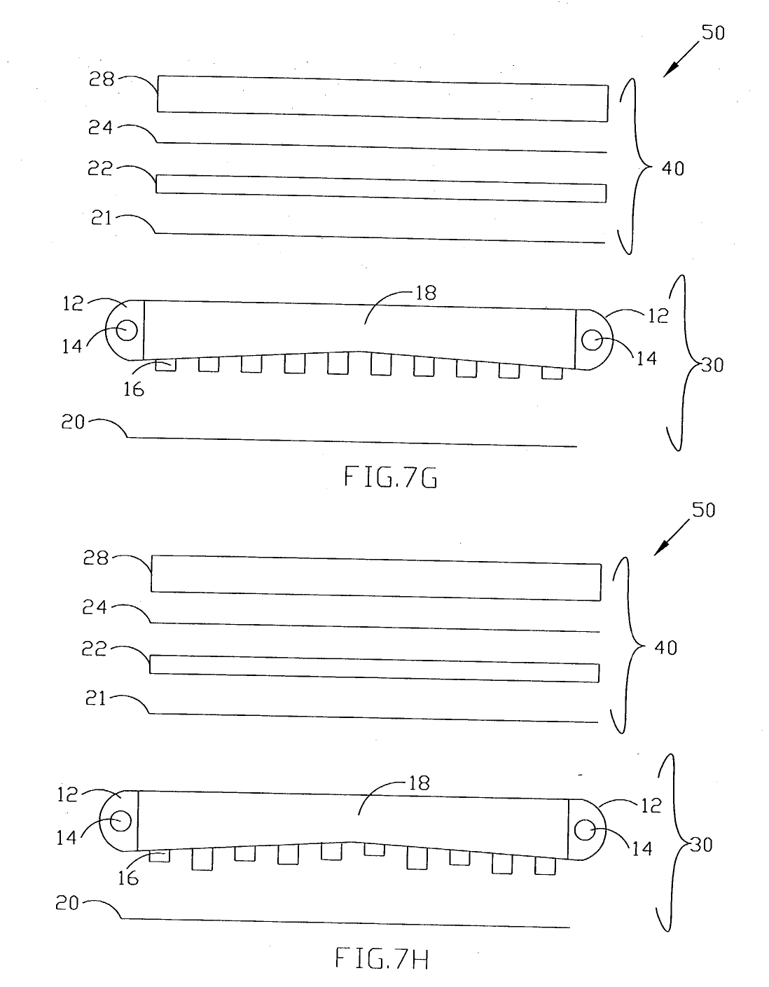

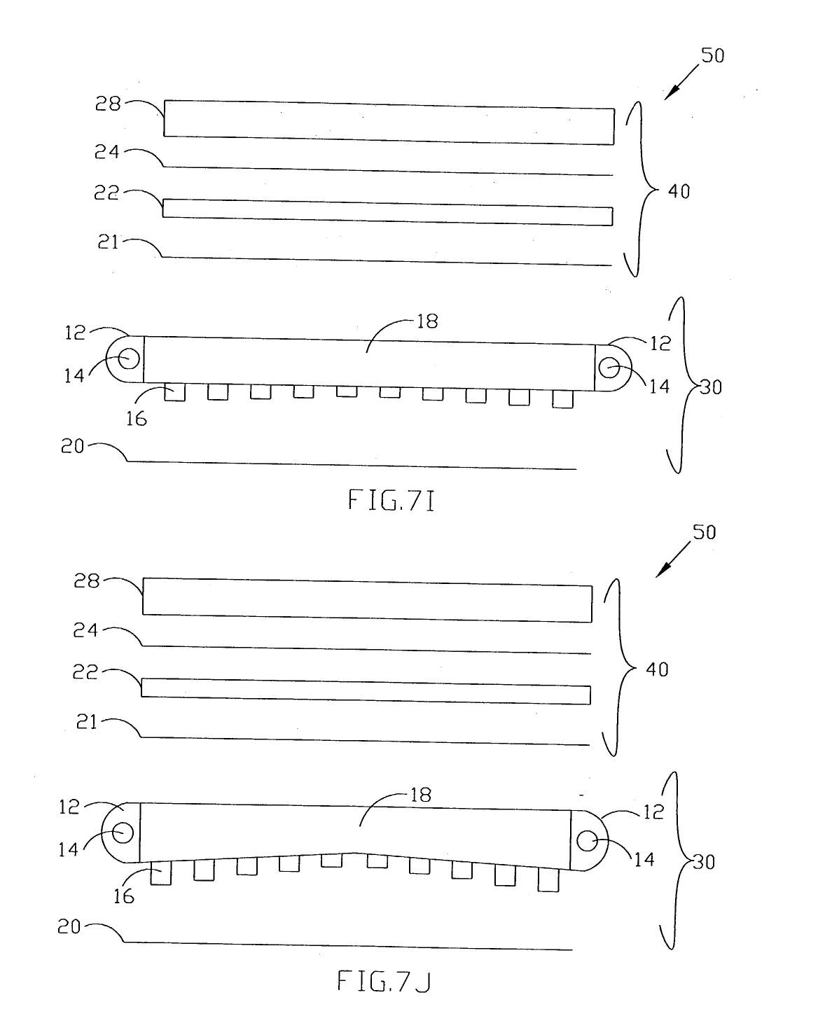

The structure after combining a side-lamp backlight module 30 with different arrangements of the plurality of cylinder reflectors and a liquid crystal display panel 40 will be as shown in FIG. 7A-7J. A liquid crystal display device 50 comprises one or a plurality of lamp housings 12, one or a plurality of lamps 14, a plurality of cylinder reflectors 16, a light guide plate 18, a reflector 20, a protection sheet 21, a prism sheet 22, a diffuser 24, and a liquid display panel 28. When the lamp 14 projects light into the light guide plate 18, one part of the light will be projected to the plurality of cylinder reflectors 16 and then be reflected to project from the top surface of the light guide plate 18 after many times full reflection, the other part of the light will be reflected by the reflector 20 below the bottom surface of the light guide plate 18 to project from the top surface of the light guide plate 18. The light projected from the top surface of the light guide plate 18 will be more uniform after passing through the diffuser 24, and the liquid crystal display device 50 will have uniform and adaptive luminance in the range of the angle of vision after the light passes through the prism sheet 22.

As shown in FIG. 7A, the light guide plate 18 is a double-side-lamp and parallel light guide plate 18 which has cylinder reflectors 16 protruding from low to high from the bottom surface inside the light guide plate 18 with the same interval from the lamp 14 side to the opposite direction toward the lamp 14; as shown in FIG. 7B, the light guide plate 18 is a double-side-lamp and parallel light guide plate 18 which has cylinder reflectors 16 protruding with non-uniform height from the bottom surface inside the light guide plate 18 with the same interval from the lamp 14 side to the opposite direction toward the lamp 14; as shown in FIG. 7C, the light guide plate 18 is a double-side-lamp and double-wedge-shaped light guide plate 18 which has cylinder reflectors 16 protruding from low to high from the bottom surface inside the light guide plate 18 with the same interval from the lamp side to the opposite direction toward the lamp; as shown in FIG. 7D, the light guide plate 18 is a double-side-lamp and double-wedge-shaped light guide plate 18 which has cylinder reflectors 16 protruding with non-uniform height from the bottom surface inside the light guide plate 18 with the same interval from the lamp 14 side to the opposite direction toward the lamp 14; as shown in FIG. 7E, the light guide plate 18 is a double-side-lamp and parallel light guide plate which has cylinder reflectors protruding from low to high from the bottom surface outside the light guide plate with the same interval from the lamp side to the opposite direction toward the lamp; as shown in FIG. 7F, the light guide plate 18 is a double-side-lamp and parallel light guide plate 18 which has cylinder reflectors 16 protruding with non-uniform height from the bottom surface outside the light guide plate 18 with the same interval from the lamp 14 side to the opposite direction toward the lamp 14; as shown in FIG. 7G, the light guide plate 18 is a double-side-lamp and double-wedge-shaped light guide plate 18 which has cylinder reflectors 16 protruding from low to high from the bottom surface outside the light guide plate 18 with the same interval from the lamp 14 side to the opposite direction toward the lamp 14; as shown in FIG. 7H, the light guide plate 18 is a double-side-lamp and double-wedge-shaped light guide plate 18 which has cylinder reflectors 16 protruding with non-uniform height from the bottom surface outside the light guide plate 18 with the same interval from the lamp 14 side to the opposite direction toward the lamp 14; as shown in FIG. 71, the light guide plate 18 is a double-side-lamp and parallel light guide plate 18 which has cylinder reflectors 16 protruding from high to low from the bottom surface outside the light guide plate 18 with the same interval from the lamp 14 side to the opposite direction toward the lamp 14; and as shown in FIG. 7J, the light guide plate 18 is a double-side-lamp and double-wedge-shaped light guide plate 18 which has cylinder reflectors 16 protruding from high to low from the bottom surface outside the light guide plate 18 with the same interval from the lamp 14 side to the opposite direction toward the lamp 14.

What is said above is only a preferred embodiment of the invention, which is not to be used to limit the claims of the invention; any change of equal effect or modifications that do not depart from the essence displayed by the invention should be limited in what is claimed in the following.

What is claimed is:

1. A backlight module, comprising:
a light guide plate, wherein said light guide plate comprises a top surface and a bottom surface;
at least one lamp, wherein said at least one lamp is implemented beside at least one side of said light guide plate to make light be projected into said light guide plate;
at least one lamp housing, wherein said at least one lamp housing surrounds said at least one lamp to reflect light; and
a plurality of cylinder reflectors, wherein said plurality of cylinder reflectors locate around said bottom surface of said light guide plate and said plurality of cylinder reflectors have different height to break full reflection of light to make light be reflected to project from said top surface of said light guide plate.

2. The backlight module according to claim 1, wherein said plurality of cylinder reflectors locate inside said light guide plate and said plurality of cylinder reflectors are arranged from low to high with a fixed interval from at least one side of said light guide plate implemented with said at least one lamp to the opposite direction toward said at least one lamp.

3. The backlight module according to claim 1, wherein said plurality of cylinder reflectors locate inside said light guide plate and said plurality of cylinder reflectors are arranged with non-uniform height with a fixed interval from at least one side of said light guide plate implemented with said at least one lamp to the opposite direction toward said at least one lamp.

4. The backlight module according to claim 1, wherein said plurality of cylinder reflectors locate outside said light guide plate and said plurality of cylinder reflectors are arranged from low to high with a fixed interval from at least one side of said light guide plate implemented with said at least one lamp to the opposite direction toward said at least one lamp.

5. The backlight module according to claim 1, wherein said plurality of cylinder reflectors locate outside said light guide plate and said plurality of cylinder reflectors are arranged from high to low with a fixed interval from at least one side of said light guide plate implemented with said at least one lamp to the opposite direction toward said at least one lamp.

6. The backlight module according to claim 1, wherein said plurality of cylinder reflectors locate outside said light guide plate and said plurality of cylinder reflectors are arranged with non-uniform height with a fixed interval from at least one side of said light guide plate implemented with said at least one lamp to the opposite direction toward said at least one lamp.

7. The backlight module according to claim 1, wherein said light guide plate is a parallel plate.

8. The backlight module according to claim 1, wherein said light guide plate is a wedge-shaped plate.

9. The backlight module according to claim 1, wherein said light guide plate is a double-wedge-shaped plate of which the thickness at two sides are thicker than the thickness in the center part.

10. A liquid crystal display device, comprising:
a light guide plate, wherein said light guide plate comprises a top surface and a bottom surface;
at least one lamp, wherein said at least one lamp is implemented beside at least one side of said light guide plate to make light be projected into said light guide plate;
at least one lamp housing, wherein said at least one lamp housing surrounds said at least one lamp to reflect light;
a plurality of cylinder reflectors, wherein said plurality of cylinder reflectors locate around said bottom surface of said light guide plate and said plurality of cylinder reflectors have different height to break full reflection of light to make light be reflected to project from said top surface of said light guide plate;
a reflector, wherein said reflector locates below said bottom surface of said light guide plate to reflect light; and
a liquid crystal display panel, wherein said liquid crystal display panel locates above said top surface of said light guide plate.

11. The liquid crystal display device according to claim 10, wherein said plurality of cylinder reflectors locate inside said light guide plate and said plurality of cylinder reflectors are arranged from low to high with a fixed interval from at least one side of said light guide plate implemented with said at least one lamp to the opposite direction toward said at least one lamp.

12. The liquid crystal display device according to claim 10, wherein said plurality of cylinder reflectors locate inside said light guide plate and said plurality of cylinder reflectors are arranged with non-uniform height with a fixed interval from at least one side of said light guide plate implemented with said at least one lamp to the opposite direction toward said at least one lamp.

13. The liquid crystal display device according to claim 10, wherein said plurality of cylinder reflectors locate outside said light guide plate and said plurality of cylinder reflectors are arranged from low to high with a fixed interval from at least one side of said light guide plate implemented with said at least one lamp to the opposite direction toward said at least one lamp.

14. The liquid crystal display device according to claim 10, wherein said plurality of cylinder reflectors locate outside said light guide plate and said plurality of cylinder reflectors are arranged from high to low with a fixed interval from at least one side of said light guide plate implemented with said at least one lamp to the opposite direction toward said at least one lamp.

15. The liquid crystal display device according to claim 10, wherein said plurality of cylinder reflectors locate outside said light guide plate and said plurality of cylinder reflectors are arranged with non-uniform height with a fixed interval from at least one side of said light guide plate implemented with said at least one lamp to the opposite direction toward said at least one lamp.

16. The backlight module according to claim 10, wherein said light guide plate is a parallel plate.

17. The backlight module according to claim 10, wherein said light guide plate is a wedge-shaped plate.

18. The backlight module according to claim 10, wherein said light guide plate is a double-wedge-shaped plate of which the thickness at two sides are thicker than the thickness in the center part.
